(19) United States
(12) Patent Application Publication
(10) Pub. No.: US 2020/0334092 A1
(43) Pub. Date: Oct. 22, 2020

(54) SYSTEM AND METHOD FOR IDENTIFYING A CAUSE OF A FAILURE IN OPERATION OF A CHIP

(71) Applicant: Vtool Ltd, Tel-Aviv (IL)

(72) Inventor: Anna Marie RAVITZKI, Montigac (FR)

(73) Assignee: Vtool Ltd, Tel-Aviv (IL)

(21) Appl. No.: 16/385,848

(22) Filed: Apr. 16, 2019

(51) Int. Cl. G06F 11/07; G06K 9/62; G06F 11/22

(52) U.S. Cl. CPC G06F 11/079; G06F 11/2268; G06K 9/6267

(57) ABSTRACT

A system and method for presenting information related to an operation of a chip may include obtaining an input file including entries that record an operation of a chip; based on at least one parameter, identifying at least one pattern of entries in the input file; and based on analyzing a plurality of occurrences of the pattern, selecting an occurrence of the pattern that records a root cause of a problem.

### FIELD OF THE INVENTION

The present invention relates generally to identifying a cause of a failure. More specifically, the present invention relates to using identifying a root cause of a failure related to an operation or simulation of an electronic circuit.

### BACKGROUND OF THE INVENTION

Proper integrated circuit (chip) design and production must consider several factors that relate to electronics, circuits, analog functions, logic, and other functionalities. For example, before a chip is released for production, the chip may typically undergoes a series of tests, e.g., design verification, simulation tests and tests of prototypes or versions, to ensure that the manufactured chip will operate as planned and expected.

The terms “test” and “testing” as referred to herein may relate to any operation directed at checking or testing a chip, e.g., simulation, verification, test-run and the like. Testing as referred to herein may be performed using a simulation of a chip, e.g., a software representation of a chip's operation or logic, testing as referred to herein may be performed using a hardware chip.

Tests typically generate two primary types of outputs: log files, and simulation signals state database (also referred to as “waves”). Log files often include textual messages generated by one or more parts of the testing environment. For example, log files may generate information and/or messages relating to an event, a state of a component, an error, or other similar operation that occurred during the simulation.

To identify problems in a chip (debugging), a user (e.g., engineer) reads a log files and looks for lines or entries that indicate a problem. The process of reading log files (that may contain thousands upon thousands of entries) is time consuming, labor intensive and subject to further error, since it requires the engineer to process a large amount of data, navigate back and forth through countless events and pieces of data.

### SUMMARY OF THE INVENTION

In some embodiments, an input file including entries that record an operation of a chip may be obtained. Based on at least one parameter, at least one pattern of entries in the input file may be identified and, based on analyzing a plurality of occurrences of the pattern, an occurrence of the pattern that records a root cause of a problem may be selected. In an embodiment a selection may be received from a user of a field included in an entry including the parameter and visually present a set of entries including the parameter, wherein a visualization of an entry is according to a value included in the field.

In one embodiment, a selection may be received from a user of a function of an attribute of a field included in an entry including the parameter and, based on the function, identify at least one pattern of entries in the input file. In an embodiment the system may visually present occurrences of each of the set of entries included in the pattern in a respective set of regions, wherein the occurrences are presented according to a common axis.

In one embodiment, the system may visually present occurrences of entries related to a set of parameters; receive a selection of at least one of: one or more of the parameters and a range in a common axis used for presenting the occurrences; and identify at least one pattern of entries in the input file based on the selection. In one embodiment, a selection may be received from a user of a set of parameters; receive from the user a selection of an attribute of at least one field included in an entry that includes at least one of the selected parameters; identify patterns of entries based on the set of parameters; and classify the patterns based on the attribute.

In one embodiment, the system may identify a plurality of patterns of entries in the input file and cluster the patterns based on an attribute of at least one field in at least one entry. The field may be selected based on input or selection of a user. In one embodiment, a selection may be received from a user of a set of parameters; and the system may create, based on the set of parameters, a structured data file, wherein: a first field in an entry in the file includes a value from a first field in a first entry in the input file; and a second field in the entry in the file includes a value from a second field in a second entry in the input file.

In one embodiment, the system may associate at least one entry in at least one pattern with a rank value based on a relevance to an investigated event and present to a user the entry with the highest rank value. In one embodiment, the system may iteratively: receive input from the user indicating a level of relevance of the rank value to an investigated event; based on the input, update a rule for at least one of: identifying a pattern, and associating entries with rank values; and present to a user the entry with the highest rank value. Other aspects and/or advantages of the present invention are described herein.

### BRIEF DESCRIPTION OF THE DRAWINGS

Non-limiting examples of embodiments of the disclosure are described below with reference to figures attached hereto that are listed following this paragraph. Identical features that appear in more than one figure are generally labeled with a same label in all the figures in which they appear. A label labeling an icon representing a given feature of an embodiment of the disclosure in a figure may be used to reference the given feature. Dimensions of features shown in the figures are chosen for convenience and clarity of presentation and are not necessarily shown to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows a block diagram of a computing device according to illustrative embodiments of the present invention;

FIG. 2 shows a portion of a log file according to illustrative embodiments of the present invention;

FIG. 3 shows a screenshot according to illustrative embodiments of the present invention;

FIG. 4 shows an example of a structured data file according to illustrative embodiments of the present invention; and

FIG. 5 shows a flowchart of a method according to illustrative embodiments of the present invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items.

In the description and claims of the present application, each of the verbs, “comprise” “include” and “have”, and conjugates thereof, are used to indicate that the object or objects of the verb are not necessarily a complete listing of components, elements or parts of the subject or subjects of the verb. Unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of an embodiment as described. In addition, the word “or” is considered to be the inclusive “or” rather than the exclusive or, and indicates at least one of, or any combination of items it conjoins.

Unless explicitly stated, the method embodiments described herein are not constrained to a particular order in time or to a chronological sequence. Additionally, some of the described method elements can occur, or be performed, simultaneously, at the same point in time, or concurrently. Some of the described method elements may be skipped, or they may be repeated, during a sequence of operations of a method.

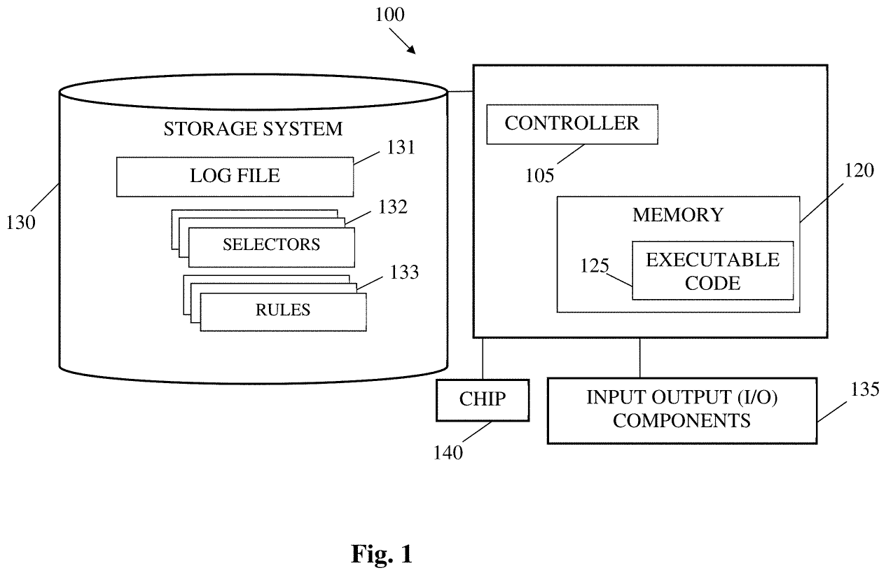

Reference is made to FIG. 1, showing a non-limiting, block diagram of a computing device or system 100 that may be used to identify a cause of a failure in operation of a chip 140 according to some embodiments of the present invention. Computing device 100 may include a controller 105 that may comprise a hardware controller. For example, computer hardware processor or hardware controller 105 may be, or may include, a central processing unit processor (CPU), a chip or any suitable computing or computational device. Computing system 100 may include a memory 120, executable code 125, a storage system 130 and input/output (I/O) components 135. Controller 105 (or one or more controllers or processors, possibly across multiple units or devices) may be configured (e.g., by executing software or code) to carry out methods described herein, and/or to execute or act as the various modules, units, etc., for example by executing software or by using dedicated circuitry. More than one computing devices 100 may be included in, and one or more computing devices 100 may be, or act as the components of, a system according to some embodiments of the invention.

Memory 120 may be a hardware memory. For example, memory 120 may be, or may include machine-readable media for storing software e.g., a Random-Access Memory (RAM), a read only memory (ROM), a memory chip, a Flash memory, a volatile and/or non-volatile memory or other suitable memory units or storage units. Memory 120 may be or may include a plurality of, possibly different memory units. Memory 120 may be a computer or processor non-transitory readable medium, or a computer non-transitory storage medium, e.g., a RAM. Some embodiments may include a non-transitory storage medium having stored thereon instructions which when executed cause the processor to carry out methods disclosed herein.

Executable code 125 may be an application, a program, a process, task or script. A program, application or software as referred to herein may be any type of instructions, e.g., firmware, middleware, microcode, hardware description language etc. that, when executed by one or more hardware processors or controllers 105, cause a processing system or device (e.g., system 100) to perform the various functions described herein.

Executable code 125 may be executed by controller 105 possibly under control of an operating system. For example, executable code 125 may be an application that identifies a cause of a failure in operation of a chip 140 as further described herein. Although, for the sake of clarity, a single item of executable code 125 is shown in FIG. 1, a system according to some embodiments of the invention may include a plurality of executable code segments similar to executable code 125 that may be loaded into memory 120 and cause controller 105 to carry out methods described herein. For example, units or modules described herein, e.g., chip 140, may be, or may include, controller 105, memory 120 and executable code 125.

Chip 140 may be a simulation of a chip or it may be a real, hardware chip. For example, in the case of a simulation, chip 140 may be a computing device 100 that, using software, simulates operation of a chip. In another case, chip 140 may be an actual, hardware integrated circuit, e.g., connected to computing device 100 such that information related to events, states of components or any other aspect is communicated to computing device 100 and stored in log file 131.

Storage system 130 may be or may include, for example, a hard disk drive, a universal serial bus (USB) device or other suitable removable and/or fixed storage unit. As shown, storage system 130 may include log file 131, selectors 132 and rules 133 (collectively referred to hereinafter as selectors 132 and/or rules 133 or individually as selector 132 and/or rule 133, merely for simplicity purposes).

Objects in storage system 130, e.g., log file 131, selectors 132 and rules 133 may be any suitable digital data structure or construct or computer data objects that enables storing, retrieving and modifying information or values. For example, log file 131, selectors 132 and rules 133 may be files on a hard disk, objects in a database or segments of volatile or non-volatile memory.

A log file 131 may generally include or record any relevant information related to a test of chip 140, e.g., as described. A selector 132 may be any value or parameter used for identifying or selecting patterns in a log file as further described herein. The terms “pattern” and “patterns” as referred to herein may relate to a repeated set or sequence of entries in a log file 131. For example, a pattern may be a set of consecutive or sequential entries or lines in log file 131 that appears, in log file 131 more than once. A pattern may be a set or sequence of non-consecutive or non-sequential lines, e.g., a pattern may be identified based on two or more lines which are repeated in log file 131 even if some (different in each occurrence or instance of the pattern) lines appear between the two or more lines.

A pattern may be identified or discovered using any pattern recognition method or system. A pattern may be identified based on an order of entries, a time between entries (e.g., as recorded in log file 131) and so on. For example, a first and second entries during a specific time interval may be identified as a pattern regardless of which, or how many, entries are seen between the first and second entries. In another case, a pattern may be identified based on the order of entries, regardless of any intervening entries.

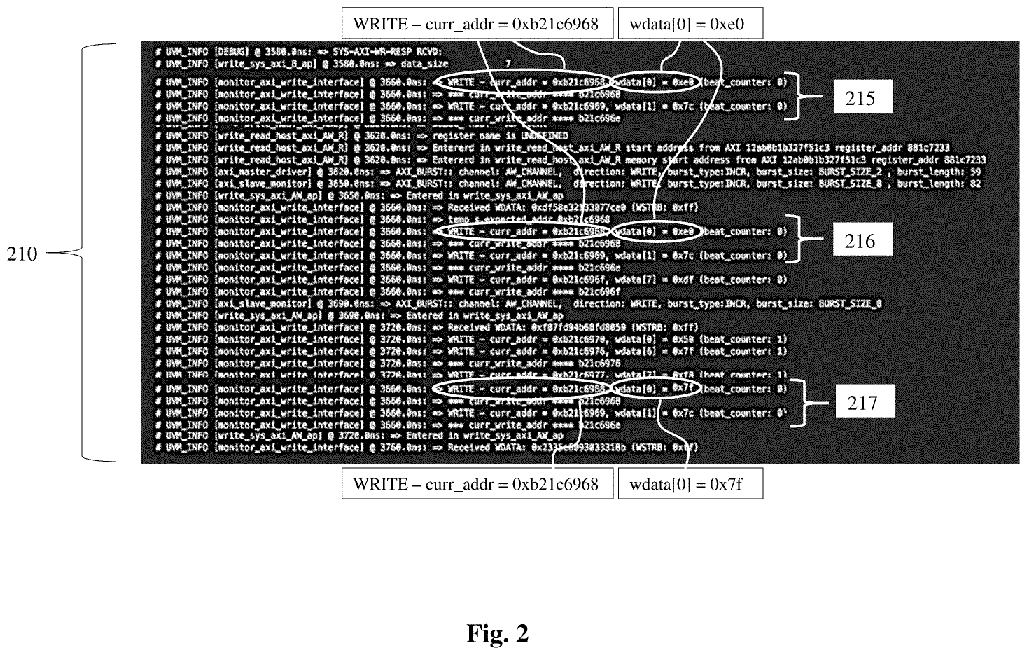

A selector 132 may be set based on input from a user, a selector 132 may be predefined, and/or a selector 132 may be automatically set or defined. For example, an engineer debugging a first component in chip 140, e.g., a USB interface subsystem, may set or select a selector 132 such that entries relevant to the USB interface are selected and used as described herein, e.g., the engineer may double click on the word “USB” in an entry (e.g., an entry displayed as shown in FIG. 2 as further described herein) to thus define a selector. In another case, selector 132 may be predefined, e.g., a selector 132 may include the term “ERROR” such that entries relevant to an error or failure are selected and used as described herein. In yet other cases or embodiments, a selector 132 may be automatically set, e.g., based on analysis of log file 131 as further described. Accordingly, a selector 132 used for identifying patterns and ranking entries as described may be defined, set or extracted from, any one of: an error message in an input (log) file, an input from a user and an entry including a specific event. An event as referred to herein may be any event recorded in log file 131, for example, an event may be a write or read of data to a memory, sending or receiving a message by a component, changing of a state of a component, initializing a component and the like.

A selector 132 may be set, defined or selected based on an indication of a user. For example, a user who is debugging a network interface card (NIC) component in chip 140 marks a set of lines in log file 131 that records events related to the NIC. For example, log file 131 may be presented on a screen and, using a mouse, the user marks lines. Controller 105 may examine the selected or marked lines, extract one or more key words therefrom and may create a selector 132 based on the extracted terms or words. For example, in the above NIC example, since the user is interested in the NIC, controller 105 may identify patterns related to the NIC, rank entries related to the NIC and/or present, to the user, a line in log file 131 that describes a root cause of a failure or problem related to the NIC component.

A selector 132 may be set, defined or selected based on a design of the chip. For example, key or central components (e.g., a memory or a communication bus) may be selected for identifying patterns, ranking entries an identifying a root cause of a problem based on a digital representation of a design of chip 140. Any rule or logic may be used for selecting one or more components in chip 140, e.g., a rule 133 may select components according to their importance level, number of connections to other components and the like.

For example, based on a design of chip 140, controller 105 may determine that the NIC is connected to a memory but is not connected to the USB interface. Accordingly, when searching for patterns that refer to the NIC, controller 105 ignore (or assign a low rank to) entries related to the USB but may consider entries related to the memory.

A selector 132 may be set, defined or selected based on source code of software or firmware (e.g., executable code 125) executed by a chip. For example, connections between software or hardware units or components in chip 140 may be used to select one or more components for which patterns are identified, messages written to log file 131, by software units may be identified and searched for in log file 131 or used for defining pattern matching or recognition. For example, if it is known that the software unit that controls the NIC always add a signature to entries it adds to log file 131 then controller 105 can identify entries related to the NIC based on the signature.

Rules 133 may be, or may include, any criterion or logic used for analyzing log file 131 and identifying a cause of a failure as further described herein. Content may be loaded from storage system 130 into memory 120 where it may be processed by controller 105. For example, a log file 131 may be loaded into memory 120 and used for identifying a cause of a failure as further described herein. Any method or operation for setting, creating, or defining a rule 133 as described herein may be used for setting, creating, or defining a selector 132. For example, selectors 132 may be included in rules 132 thus creating a selector 132 may include creating a rule 133.

In some embodiments, some of the components shown in FIG. 1 may be omitted. For example, memory 120 may be a non-volatile memory having the storage capacity of storage system 130. Accordingly, although shown as a separate component, storage system 130 may be embedded or included in system 100, e.g., in memory 120.

I/O components 135 may be, may be used for connecting (e.g., via included ports) or they may include: a mouse; a keyboard; a touch screen or pad or any suitable input device. I/O components may include one or more screens, touchscreens, displays or monitors, speakers and/or any other suitable output devices. Any applicable I/O components may be connected to computing device 100 as shown by I/O components 135, for example, a wired or wireless network interface card (NIC), a universal serial bus (USB) device or an external hard drive may be included in I/O components 135.

A system according to some embodiments of the invention may include components such as, but not limited to, a plurality of central processing units (CPU) or any other suitable multi-purpose or specific processors, controllers, microprocessors, microcontrollers, field programmable gate arrays (FPGAs), programmable logic devices (PLDs) or application-specific integrated circuits (ASIC). A system according to some embodiments of the invention may include a plurality of input units, a plurality of output units, a plurality of memory units, and a plurality of storage units. A system may additionally include other suitable hardware components and/or software components. In some embodiments, a system may include or may be, for example, a workstation, a server computer, a network device, or any other suitable computing device.

Reference is made to FIG. 2 which shows a portion of a log file 131 according to illustrative embodiments of the present invention. As shown, log file 131 may include a plurality of entries 200 each describing and recording information related to a testing of chip 140. As further shown, log file 131 may include pattern instances, occurrences or repetitions 215, 216 and 217 which are sequences of the pattern, e.g., sets or sequences of similar entries. For example, each of pattern instances 215, 216 and 217 includes, in its first line, the text “WRITE-curr_addr=0xb21c6968” and, in its second line, each of pattern instances 215, 216 and 217 includes the text “curr_addr **** b21c6968”.

In some embodiments, an automated process of debugging a chip may include obtaining an input file (e.g., log file 131) including entries that record an operation of a chip (e.g., entries 210). Based on at least one parameter (e.g., a selector 132), an automated process may identify at least one pattern in the input file. Based on a pattern in the input (log) file, an automated process may select at least one entry in the input file, the selected entry records, identifies or references a root cause of a problem.

The terms “problem” and “failure” as referred to herein, with respect to testing, may relate to any result, state or condition encountered during a test. As described, a problem or failure may be identified based on content in log file 131, which may include information describing any result, state or condition encountered during a test.

For example, log file 131 may record a test of chip 140 and may be the input file as described, using a selector 132 that finds entries that include the word “WRITE”, controller 105 may examine entries 210 in log file 131 and find pattern instances 215, 216 and 217. By further examining pattern instances 215, 216 and 217, controller 105 may discover that where, in their respective first lines, pattern instances 215 and 216 include the text “wdata[0]=0xe0”, the first line of pattern instance 217 includes the text “wdata[0]=0x7f”. Accordingly, controller 105 may select the first line of pattern instance 217 (or it may select the entire pattern instance 217 or any set of entries in entries 210) as indicating, describing or pointing to a root cause of a problem.

To find a root cause of a problem, the system (e.g., controller 105) may identify a pattern or a set of sequences of entries that represent an operational cycle of a component. Controller 105 may identify, in the set, the sequence or entry that describes, or points to, the problem. For example, controller 105 may identify patterns related to a memory component (e.g., ones including write or read operations) and search, in the patterns, an occurrence or instance where the problem begins, e.g., a failed write operation, a sequence of read/write operations that is different in one occurrence of a pattern with respect to all, other, or rest of the occurrences of that pattern.

Accordingly, based on at least one parameter, the system may identify at least one pattern of entries in an input file, and, based on analyzing a plurality of occurrences of the pattern, the embodiment may select an occurrence of the pattern that records a root cause of a problem. For example, a parameter (or selector 132) may be indicated by a user, e.g., a user may select “WRITE-curr_addr 0xb21c6968” as the parameter or selector and the system may find, in a log file, patterns that include this parameter or text, for example, provided with this parameter, controller 105 may find pattern instances 215, 216 and 217 as described.

In some embodiments, instead of finding a specific pattern instance or entry that points to a root cause of a problem, controller 105 may identify (and present to a user) an occurrence of a pattern or entry that is different from other instances or occurrences of a pattern even if no failure occurred, e.g., in a case where a test completes successfully. For example, in some cases, even though a test completes successfully, some deviations from an expected operation may be identified and indicated to a user. For example, a test that includes multiple writes of 1024 bytes to a specific address may be completed successfully, even though one of the writes only succeeded to write 512 bytes and not 1024. However, for example, since the written data was not subsequently read or used, the test completes successfully. Accordingly, since the test completed successfully, the problem (the failure of writing 1024 in one instance) may be hidden from an engineer debugging a chip. By identifying exceptions in a pattern, even in cases when a test succeeds, embodiments of the invention enable identifying or detecting problems or bugs that would otherwise remain hidden or unknown, as known in the art, such problems typically surface at a stage where the chip is already in production.

In some embodiments, a selection of a field included in an entry may be received from a user and the system may visually present, to the user, a plurality of occurrences of the field, in a respective plurality of entries of a log file. A visual presentation of occurrences of a field may be according to a value in the field or according to a value of another field in the same entry. A field selected by a user may represent or record any action or event, for example, a field or an event selected by a user may be a write/read operation to/from a memory. Referring to the write/read operation example, a visual representation may be according to the address to/from data is written/read or a visual representation may be according to the amount of data written or read.

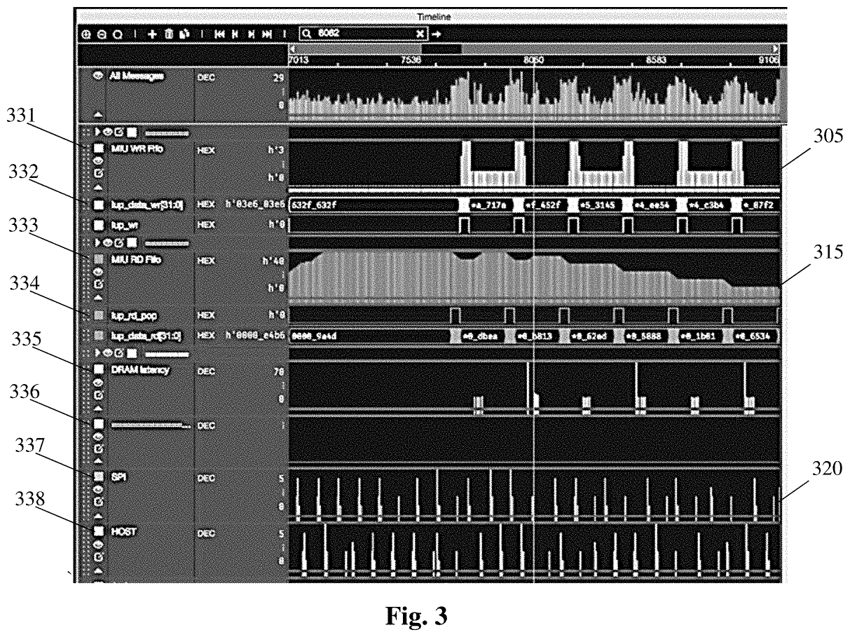

Reference is additionally made to FIG. 3, a screenshot according to illustrative embodiments of the present invention. As shown by bar charts (regions or bar graphs) 305, 315 and 320, some embodiments of the invention may visually present a number of bar charts (in a respective number of regions of a display) for a respective number of selected fields or events where the bar charts (or regions) visually show quantitative aspects related to the selected event or field. For example, the height of bars in bar chart 305 may represent the address to which data is written, e.g., a bar representing an entry with “WRITE-curr_addr=0x00000001” (low address) may be much lower or smaller than a bar representing an entry with “WRITE-curr_addr=0x00009999” (high address).

It will be noted the height of bars is only one example of a visualization, for example, colors may be used, e.g., low addresses may be shown in blue by some embodiments, medium addresses may be shown yellow and high addresses may be red. In yet other examples, the system may set the width of bars in a bar chart according to an address.

Some embodiments of the invention may present a visualization of events based on any number of fields in entries. For example, if a user selects one field (or selector 132) then a visual representation or display may be based on a value in the field as described. However, a user may select a first field (e.g., one recording a write operation) and then select a second field, e.g., the second field may be a field in the entry that records the amount of data written, the memory address to which data is written, the time from start to end of the write operation, and so on. In an embodiment the system may present a visual representation or display of a selected event in an entry (a first field) based on one or more additional fields in the entry. Complex functions may be used. For example, the height or color of bars in bar chart 320 may be set based on dividing/summing a value in a first field by/with the value of a second field. Accordingly, a visual representation of occurrences of an event recorded in a log file may be based on a function of any number of fields in an entry.

Advantage of a visual representation or display of events recorded in a log file as described may be readily appreciated. For example, an engineer suspecting that a segment of a memory is faulty (e.g., the address space between 512 and 1024) can quickly see or identify all events where data was written to that memory segment based on the height or color of bars representing write operations as described. In another example, an engineer suspecting a problem may be related to the time a write operation requires may select the start and end time fields in an entry that records a write operation (and possibly select a function, e.g., [end time-start time]) and in an embodiment the system may present a visual representation of write operations where the height, width or color of bars in the visual representation is set according to the selected function thus the engineer can quickly and easily identify or focus on write operations that took longer than other write operations.

For example, controller 105 may find entries in log file 131 that match a selection of a user, for example, the selection may be a write performed by a USB component, controller (e.g., entries that record a write operation performed by a specific component), controller 105 may extract values of the selected fields (e.g., the time fields in the above example), apply a functions to the fields (e.g., subtract end-time from start-time as recorded in each entry) and set an attribute of a visualization of each occurrence of the selected event according to a result of the function. Of course, controller 105 may identify and present an entry (or set of entries) without any input from a user, that is, the process of identifying patterns and/or exceptions may be fully automated, that is the system may not require any input from a user in order to identify patterns and/or classify or cluster patterns as described.

In some embodiments, graphical user interface (GUI) may be used, e.g., to enable a user to make selections as described. For example, a pull-down menu may enable a user to select a function after selecting two or more fields in an entry, a popup box may enable a user to define a word or phrase as a selector 132 and so on.

Some embodiments may include visually presenting events (recorded in occurrences of each of a set of entries included in instances of a pattern) in a respective set of regions, wherein the events are presented according to a common axis. For example, as described, based selections of a user, controller 105 may identify patterns of entries, identify a set of reoccurring events therein and visually or graphically present the set of reoccurring events in a respective set of regions along a common axis that may be a timeline or an order of appearance in log file 131. For example, as shown by bar charts 305, 315 and 320, some embodiments may visually present occurrences of multiple events, e.g., based on a respective set of multiple selections or selectors 132. For example, bar chart 305 may visually present writes to a memory segment, bar chart 315 may visually present writes to first in first out (FIFO) buffer and bar chart 320 may visually present a message received by a component of chip 140. By stacking regions showing different events one on top of the other and according to a common axis, embodiments of the invention enable a user to quickly and easily see or identify connections or relations between events.

For example, suspecting a problem related to writing data to a memory is related to a specific message received prior to the write, a user may select the write operation event (e.g., to cause a display of bar chart 305) and additionally select the event of the message being received (e.g., to cause a display of bar chart 320). In such case, the presentation of both the memory write events and message reception events in regions stacked as shown in FIG. 3 and arranged along a common timeline enables the user to easily see the connection and/or relation between the reception of the message and the memory write thus providing the user with a powerful debug tool without which a user is forced to inspect countless number of entries looking for a connection between events.

In some embodiments, a pattern in log (input) file 131 may be identified based on a function, rule or criterion selected by a user and/or included in rules 133. For example, a function rule or criterion may be, may include, or may be related to an attribute or value of one or more fields in an entry, e.g., an address range (e.g., a memory address between 0 and 512) or a function rule or criterion selected by a user may be a threshold (e.g., more than 1024 bytes are written or read) or a function rule or criterion may be an attribute of a value (e.g., a memory address divisible by 4). For example. provided with a function, rule or criterion (e.g., set or defined by a user as described or included in rules 133), controller 105 may search log file 131 for entries that match or meet the rule, function or criterion and identify patterns that include the entries. A function rule or criterion may be related to any number of events and/or fields in entries. For example, a user may select a specific component of interest (e.g., a buffer, a NIC) by clicking on text in an entry (e.g., “USB_1”), then, by clicking on text describing a message, select a message received by the NIC and then define a criterion. For example, using a pulldown menu after clicking on text in an entry such as “msg_0”, the user can indicate only messages that are larger than 512 bytes are of interest. Provided with such selections, rules or criteria, controller 105 may search log file 131 for patterns, entries or events that include, or that are related to, events in which the NIC receives messages that are larger than 512 bytes and events found may be graphically or visually presented as described.

A rule for searching patterns or entries may be created based on multiple fields in an entry and/or based on multiple fields in multiple entries. For example, a user can select a message in a first entry, a message size in a second entry and a source or destination of the message in a third entry, in such case, controller 105 may search for (and present as described) entries that match all the selected criteria, e.g., controller 105 may present sets of entries that include information related to the message where the message size and source are as indicated by the user.

Advantages of identifying patterns or entries based on complex rules as described will be appreciated by engineers and other professionals. For example, instead of searching, in a log file that typically includes millions or more entries, entries related to a scenario of interest, e.g., when a component receives a message of specific size after a specific amount of data is written to a specific memory address, an engineer can define rules as described and be provided with events that correspond, or are related to, the specific scenario of interest.

Some embodiments may include visually presenting occurrences of entries related to a set of parameters or events, receiving a selection of one or more of the parameters or events and/or a selection of a range in a common axis used for presenting the occurrences and identifying at least one pattern of entries in an input file based on the selection.

For examples, controller 105 may initially visually present occurrences related to the set of parameters, components or events 331 through 338, e.g., these parameters, components or events may be automatically selected by controller 105 based on an initial set selected by a user, based on machine learning techniques, based on rules 133 and/or based on automatically selected one or more selectors 132. Presented with the set of 331 through 338 parameters as shown, a user may select some of these parameters, e.g., determining that only host 338, SPI 337 and lup_rd_pop 334 are relevant to a problem being debugged, the user may select these parameters, components or events and, in response, controller 105 may search and identify one or more patterns of entries, in log file 131, that include, or are related to, host 338, SPI 337 and lup_rd_pop 334.

As described, some embodiments may receive a selection of a time range. For example, a user may mark an area from start to end point along the vertical axis on a screen and controller 105 may zoom into the marked area such that the display is enlarged, showing only events in the selected time range. Other methods of zooming into a portion of a display may be used, e.g., rolling a mouse wheel and the like. The combination of enabling a user to select the events or selectors (e.g., host 338, SPI 337 and lup_rd_pop 334 as described), selecting a time range and stacking views of events as described enable a user to quickly and intuitively identify problems, e.g., identify relations or connections between events and thus identify causes of problems.

Some embodiments may receive, from a user, a selection of one or more parameters (e.g., a selection of SPI 337 and lup_rd_pop 334), receive, from the user, a selection of an attribute of at least one field included in an entry that includes at least one of the selected parameters, identify patterns of entries based on the set of parameters, and classify the patterns based on the attribute.

For example, a parameter or event selected may be an error, e.g., represented in a line or entry in log file 131 by the “Error_write_USB” in a line that includes the text “Error_write_USB, Err_val=1”. A user may double click on the “Error_write_USB” portion to thus select a parameter or selector as described and the user may further select the field “Err_val” as the attribute or classifier of/for Error_write_USB. Assuming that some entries in log file 131 include “Error_write_USB, Err_val=1”, other lines include “Error_write_USB, Err_val=0” and yet other lines include “Error_write_USB, Err_val=5”, controller 105 may identify three different classes of patterns that respectfully include the three different values of the filed or classifier as described, e.g., in the above example, controller 105 may classify patterns or entries for each of the 0, 1 and 5 values of the selected attribute or field.

Patterns or entries may be presented to a user based on their class. For example, to see what typically happens when “Error_write_USB, Err_val=5”, or to see what leads to a situation where “Error_write_USB, Err_val=5”, the engineer selects the “Err_val” field as the attribute of the “Error_write_USB” and further selects (e.g., from a pulldown menu) the value of 5, in such case, controller 105 may, based on such selection, search for, and classify (or associate with a specific class), sequences of entries (or patterns) that include, or that are related to, a situation where Err_val is 5. If a no specific value of an attribute is received from a user then controller 105 may identify all different values or content (e.g., specific text strings) that a field, attribute or classifier can have or include and classify entries or patterns based on the different values or content. A visual presentation of events as described may be according to classes, e.g., patterns belonging to a specific class may be presented, a number of classes may be presented or a presentation may be based on a class selected by a user.

Although for the sake of clarity and simplicity, a selection of a single attribute or classifier (Err_val) is described herein, it is understood that any number of attributes or classifiers may be selected for a parameter. For example, if states, events or results of operations, related to a USB component in chip 140, are recorded in log file 131 by lines such as “Error_write_USB, Err_val=5, xx=7, yy=9” where values of xx and yy may be different in different lines, then a user may select or define a class by selecting a specific value of Err_val (a first attribute of, or classifier for, Err_val) another specific value for xx (second attribute or classifier) and so on, and controller 105 may classify patterns or entries based on matching them with a set or attributes of Err_val.

In some embodiments, a parameter may be selected from a first line or entry of log file 131 and an attribute may be selected from a second, different entry or line. For example, assuming that a line typically preceding the line with Error_write_USB in the above example includes “Error_init_USB, init_result=zz”, where zz can be one of a set of values. In such case, a user may select Error_write_USB as the parameter of interest as in the above example. However, instead of, or in addition to, selecting the Err_val as described, the user can select the init_result field as the attribute or classifier. Provided with a selection of a parameter in one line and an attribute on another, different line, controller 105 may classify sets of entries or patterns based on combinations of values or attributes of fields in two or more different lines in log file 131. Accordingly, classes produced by controller 105 may represent different, specific situations, events or flows, e.g., a first class may represent a flow where init_result=3 and Err_val=5, a second class may represent a flow where init_result=9 and Err_val=0 and so on.

In some embodiments, selecting an entry (either to be shown to a user or as recording a root cause of a problem) as described may be based on classifying a plurality of patterns and events and selecting at least one entry according to a class of a pattern or an event. For example, rules 133 may be used for classifying patterns in log file 131 according to a component in a chip, e.g., a first class may identify, or be related to, patterns related to a USB interface and a second class may be associated with patterns that include sequences of entries related to a network interface. For example, a method may first identify all the patterns in log file 131 that are associated with a class and subsequently identify an entry in one of the patterns as described.

In some embodiments, classifying entries or patterns in log file 131 may be based on an event. For example, if a write error caused a crash, then a class that includes entries related to a write of data to a memory may be defined and used as described. In some embodiments, classifying patterns or entries in log file 131 may be based on time or a time interval, for example, one or more classes may be automatically defined based on events occurring 10 milliseconds before a crash, e.g., a class may include components active right before a crash, events occurring immediately before the crash and so on.

Classifying patterns or entries or associating patterns or entries with a class may be done, for example, using lists, pointers and the like. For example, associating entries or patterns with a class may include creating a list of entry numbers (e.g., a sequence or running numbers of entries in log file 131) and associating the list with a class value or description. A selector 132 or rule 133 may include, or be used to define, one or more classes.

Some embodiments may include identifying a plurality of patterns of entries in the input file based on the selected field and clustering the patterns based on an attribute of the selected field. For example, in order to identify a plurality of patterns (sequences or repeating sets or groups of lines in log file 131), controller 105 may relate or compare fields in lines, e.g., selecting at least one field in an entry and identifying lines that include the field and/or cluster or classify lines based on a value of the field, or controller 105 may use machine or deep learning, artificial intelligence (AI) or neural network (NN). A NN may refer to an information processing paradigm that may include nodes, referred to as neurons, organized into layers, with links between the neurons. The links may transfer signals between neurons and may be associated with weights. A NN may be configured or trained for a specific task, e.g., pattern recognition or classification. Training a NN for the specific task may involve adjusting these weights based on examples. Typically, the neurons and links within a NN are represented by mathematical constructs, such as activation functions and matrices of data elements and weights. A processor, e.g. controller 105, or a dedicated hardware device may perform the relevant calculations. In an embodiment the system, e.g., controller 105, may train a deep learning model based on data in many log files 131 or any other relevant data. Using the model, the system may cluster or identify patterns.

For example, controller 105 may automatically select a specific memory address (first field), e.g., 0xb21c6968 in a line including ““WRITE-curr_addr=0xb21c6968, wdata[0]=0xe0 (beat_counter: 0)” and further automatically select an amount of data to write (second field), e.g., 0xe0 in the above example, and controller 105 may then find patterns and cluster the patterns based on the memory address to which data is written and further based on the amount of data written. For example, the fields curr_addr and wdata[0] that respectively include the values 0xb21c6968 and 0xe0 may include different values in different entries in log file 131, and, accordingly, a first cluster created or defined (and presented as described) by controller 105 may be, or may include, lines or patterns that record writing 128 bytes to an address between 0 and 512, a second cluster may be, or may include lines or patterns that record writing up to 512 to address 0xd0, and so on.

Some embodiments may receive, from a user, a selection of a set of parameters (e.g., as described), and create, based on the set of parameters, a structured data file, wherein a first field in a line (or entry) in the structured data file includes a value from a first field in a first entry in an input file and a second field in the line or entry includes a value from a second field in a second entry in the input file. A structured data file created as described may be an electronic spreadsheet (e.g., an Excel file) or any other file or object created and populated with data according a predefined format.

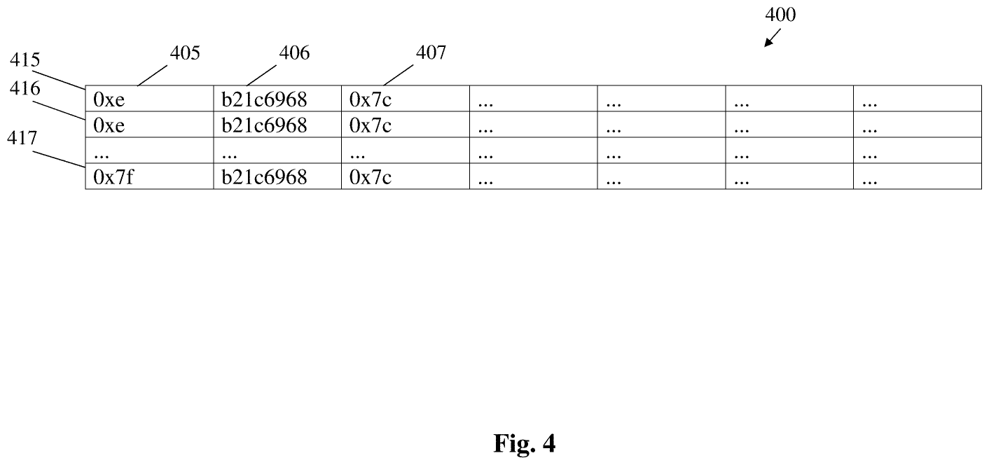

Reference is made to FIG. 4 showing an example of a structured data file 400 that includes rows 415, 416 and 417 and columns 405, 406 and 407. For the sake of simplicity, a cell as referred to herein may reference an intersection of a row in column in file 400, e.g., the intersection of row 415 and column 405 may be referred to as cell (415,405). For example, with reference to patterns shown in FIG. 2, controller 105 may store, in a first cell in each row, the value of field wdata[0] found in the first line of each of patterns 215, 216 and 217, e.g., 0xe0 for patterns 215 and 216 but 0x7f for pattern 217. Similarly, controller 105 may store the value of filed curr_write_addr in cells (415,406), (416,406) and (417,406), store a value of field wdata[0] in cells (415,407), (416,407) and (417,407) and so on.

Providing data related to patterns in the form of a structured data file enables using or applying a many (possibly known in the art) algorithms, techniques, systems or methods for analyzing data. For example, many algorithms, techniques, systems or methods known in the art that are unsuitable (or simply can't) process data in log file 131 are well adapted to process structured data, e.g., in Excel files or other file formats as exemplified by file 400. Accordingly, by creating a structured data file 400 as described, some embodiments of the invention enable using powerful techniques for identifying various aspects related to operation of chip 140, e.g., provided with structured data file 400 known algorithms or techniques may be readily used to find patterns, exceptions, flows and the like.

In some embodiments, controller 105 may associate one or more entries in one or more patterns, with a rank value based on a relevance to an investigated event. Controller 105 may select one or more entries to be presented to a user based on their respective rank values. For example, controller 105 may present or highlight, e.g., on a monitor or screen, the entry with the highest rank value, or a set of entries with the top rank values.

In some embodiments, controller 105 may associate one or more entries in/or one or more patterns, with a rank based on a design of the chip. For example, key, important or central components (e.g., a memory or a communication bus) identified in a chip design and appearing in entries or patterns may cause controller 105 to associate the entries or patterns with a high rank. In another example, connections between components, identified by examining a chip design, may be used, by controller 105 in ranking entries or patterns. For example, based on a design of chip 140, controller 105 may determine that the NIC is connected to a memory but is not connected to the USB interface. Accordingly, if the NIC is mentioned in an error or crash entry, controller 105 may raise, or set high, a rank of entries that include the memory but leave unchanged, or set low, the rank of entries including the USB.

In some embodiments, controller 105 may associate entries and/or patterns with a rank based on a source code of software and/or firmware (e.g., executable code 125) executed by the chip. For example, connections between software or hardware units or components in chip 140 may be identified based on source code and may be used to set or associate a rank with entries or patterns. For example, key or central units and units connected thereto may be associated with a high rank, a rank of a component may be set high because it is connected to a component mentioned in an error message (where the connection is known based on the source code, e.g., the software of a first component calls routines or APIs of a second component). In another example, based on source code or based on a design as described, controller 105 may identify that a specific register is connected or included in a specific interface. Accordingly, identifying the specific register in an error message may cause controller 105 to associate entries that mention the specific interface with a high rank, and/or controller 105 may dynamically and automatically define or create a selector 132 or rule 133 used for finding patterns, ranking entries or otherwise identify a root cause of a problem as described. A severity of an event may be deduced based on source code and/or a design. For example, a rule 133 may define that an event of an extended delay in a write operation is a non-sever event but an event of failing a write operation is sever and therefore merits a high rank or searching for patterns based on text in the entry describing the sever event.

In some embodiments, controller 105 may, iteratively: receive input from the user indicating a level of relevance of a rank value to the an investigated event; based on the input, controller 105 may update a rule for at least one of: identifying a pattern, and associating entries with a rank values; and controller 105 may select to present to a user an entry based on the entry's rank value. Accordingly, some systems and methods according to the invention may learn and improve themselves based on an interaction with a user such that their ability to accurately identify a root cause of a problem is constantly updated, improved and/or optimized.

For example, GUI buttons including the terms “Correct” and “Incorrect” may be displayed to a user on a same screen that presents selected entries, and, if the user clicks on “Incorrect”, rules 133 may be updated and the process of ranking and presenting entries may be repeated. Accordingly, a system and method may be a learning system or method.

In some embodiments, an input file (e.g., log file 131) includes data produced by at least one of: an operation of chip 140, a simulation of an operation of a chip, e.g., a software simulation as described, a verification process and/or an emulation of an operation of the chip. It will be understood that some embodiments of the invention may find a root cause of a problem based on any log file 131 produced by any testing of a chip. Accordingly, the scope of the invention is not limited to the type testing or operation of a chip, nor is the scope limited by the type of log file produced in the testing, e.g., methods described herein may be performed for any format of a log file produced by a simulation, emulation or actual run or operation of a chip.

In some embodiments, selecting an entry in an input file may be based on statistical data calculated for at least one of: a plurality of entries, a plurality of patterns and a plurality of events in the input file. In some embodiments, statistical data may be calculated using a structured data file, e.g., file 400 as described. In some embodiments, statistical performance data may be calculated based on at least one of: a plurality of entries, a plurality of patterns and a plurality of events in the input file. The statistical data may be presented to a user. For example, statistical performance data may be calculated based on identifying (possibly complex) operations, e.g., an initialization of a component, sending data over an interface and so on. For example, the number of times or frequency of an event, the percentage of successful events and so on may be calculated and presented to a user, e.g., on a screen or monitor of computing device 100.

For example, controller 105 may receive, from a user, a selection of a parameter (e.g., the user clicks on parameter 334), and controller 105 may generate statistical information for the parameter and or related field, e.g., fields in entries related to the parameter. For example, a parameter selected may be a component and a first field related to the component may indicate the number of bytes written, by the component to a memory, a second field may indicate the memory address to which data is written and so on. In this example, controller 105 may generate statistical data such as the number of times each memory was written to, an average, maximum and/or minimum number of bytes written, a histogram or frequency of amount and/or addresses used, a range of addresses used, addresses never written to and so on. Statistical data may be presented, graphically or otherwise, to a user or statistical data may be used for identifying a root cause of a problem, e.g., statistical data may be used to identify exceptions or suspicious behavior of chip 140.

Statistical performance data may include overall statistics related to a behavior of a chip under certain test conditions, e.g., relations between components within the chip. Statistical performance data may include information related to a test environment (e.g., in a simulation or in a lab). Statistical performance data may include information related to several interconnected chips that may all be under test or part of a testing environment. Statistical performance data may be presented to a user in combination, or based on, patterns and ranks as described. For example, statistical data for presentation to a user may be selected based on components, events and/or cause of a failure, all of which may be defined, identified and/or selected as described.

In some embodiments, selecting an entry may be based on appearance or absence of a specific text in at least one occurrence of a pattern. For example, based on a selector 132 and/or rule 133, an entry that includes the words “Error”, “Fail” and so on, or an entry that includes specific text such as an identifier of, or reference to, a specific component of interest in a chip, or an entry that includes specific terms such as “init”, “write” or “read” may be selected, e.g., from lines of patterns identified as described. In another case, a pattern may be identified as described, and a line or entry selected as indicating a root cause of a problem may be a line that does not include a word, term, phrase or text that appears, or is included, in other lines in the pattern. For example, if in all but one occurrences or instances of a pattern, the first line includes the text “init USB address 0x08A” and in the one occurrence the first line includes “init USB” (that is, the address part is missing), then controller 105 may select the one line as indicating a root cause of a problem.

In some embodiments, two or more patterns identified as described may be associated, or grouped, e.g., based on a rule in rules 133, to form a complex pattern. In some embodiments, a complex pattern may be identified based on a relation, order, or interleaving of two or more patterns. For example, controller 105 may identify a first pattern “A” and a second pattern “B”, and controller 105 may further identify that after each occurrence of pattern “A”, two occurrences of pattern “B” appear. Accordingly, controller 105 may define or identify a complex pattern of which an occurrence is “A”, “B”, “B”. A root cause may be identified based on a complex pattern, e.g., in the above “A” and “B” patterns example, if controller 105 identifies a sequence of “A”, “B”, “A” (an exception with respect to the “A”, “B”, “B” sequence), then controller 105 may determine that the identified sequence is related to a root cause of a failure or problem.

In some embodiments, exceptions or anomalies may be identified or discovered, even in cases when a test succeeds or is completed as expected. For example, a pattern that describes an initialization of a component may be identified as described and, in each occurrence of the pattern, the initialization may be successful, e.g., ending with the term “success”, however, controller 105 may identify one of the occurrences that, although recording successful completion of an operation, is different from other occurrences of the pattern. In such case, controller 105 may present the occurrence to a user and inform the user the occurrence does not match a rule or is otherwise an exception. Identifying anomalies or exceptions as described is an advantage that will be appreciated by engineers as they may point to a hidden problem that cannot otherwise be discovered.

Sets of selectors 132 and/or rules 133 may be saved, e.g., for a specific user, test environment and of course, a specific chip. For example, a first set of selectors 132 and/or rules 133 may be saved for an engineer who is working on a USB interface in a chip, and a second set of selectors 132 and/or rules 133 may be saved for an engineer who is working on a NIC of another or same chip. Similarly, sets of selectors 132 and/or rules 133 may be saved for a specific test environment, operational modes of a chip under test and so on. Sets of selectors 132 and/or rules 133 may be loaded into memory 120 and used as described. For example, the engineer working on the NIC may load her/his set of selectors 132 and/or rules 133, thus benefiting from the learning related to his specific work, e.g., the set loaded may be one that is already optimized (by a learning process as described) for debugging problems related to the NIC.

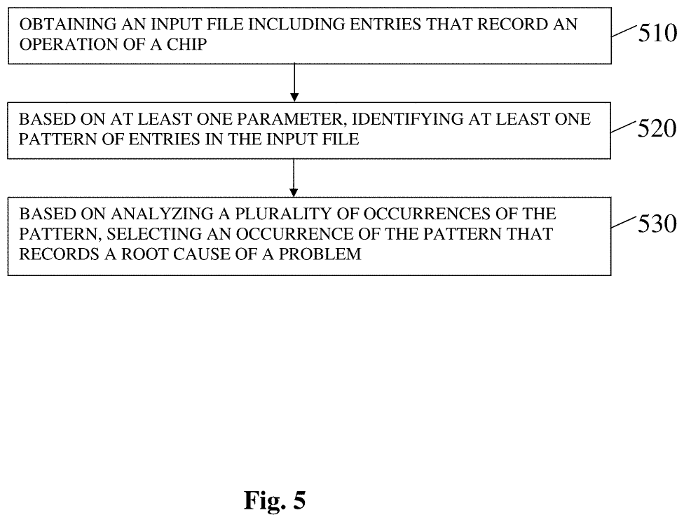

Reference is made to FIG. 5, a flowchart of a method according to illustrative embodiments of the present invention.

As shown by block 510, an input file including entries that record an operation of a chip may be obtained, for example, controller 105 may retrieve log file 131 from storage system 130.

As shown by block 520, based on at least one parameter, at least one pattern of entries in the input file may be identified. For example, controller 105 may identify entry patterns in log file 131 as described.

As shown by block 530, based on analyzing a plurality of occurrences of the pattern, an occurrence of a pattern that records a root cause of a problem may be selected. For example, controller 105 may identify and select an entry or a sequence of entries that records a root cause of a problem as described.

Descriptions of some embodiments of the invention in the present application are provided by way of example and are not intended to limit the scope of the invention. The described embodiments comprise different features, not all of which are required in all embodiments. Some embodiments utilize only some of the features or possible combinations of the features. Variations embodiments of the invention that are described, and embodiments comprising different combinations of features noted in the described embodiments, will occur to a person having ordinary skill in the art. The scope of the invention is limited only by the claims.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A computer-implemented method of presenting information related to an operation of a chip, the method comprising:
obtaining an input file including entries that record an operation of a chip;
based on at least one parameter, identifying at least one pattern of entries in the input file; and
based on analyzing a plurality of occurrences of the pattern, selecting an occurrence of the pattern that records a root cause of a problem.

2. The method of claim 1, comprising:
receiving from a user a selection of a field included in an entry including the parameter; and
visually presenting a set of entries including the parameter, wherein a visualization of an entry is according to a value included in the field.

3. The method of claim 1, comprising:
receiving from a user a selection of a function of an attribute of a field included in an entry including the parameter; and
based on the function, identifying at least one pattern of entries in the input file.

4. The method of claim 1, comprising:
visually presenting occurrences of each of the set of entries included in the pattern in a respective set of regions, wherein the occurrences are presented according to a common axis.

5. The method of claim 1, comprising:
visually presenting occurrences of entries related to a set of parameters;
receiving a selection of at least one of: one or more of the parameters and a range in a common axis used for presenting the occurrences; and
identifying at least one pattern of entries in the input file based on the selection.

6. The method of claim 1, comprising:
receiving from a user a selection of a set of parameters;
receiving from the user a selection of an attribute of at least one field included in an entry that includes at least one of the selected parameters;
identifying patterns of entries based on the set of parameters; and
classifying the patterns based on the attribute.

7. The method of claim 1, comprising:
identifying a plurality of patterns of entries in the input file; and
clustering the patterns based on an attribute of at least one field in at least one entry.

8. The method of claim 1, comprising:
receiving from a user a selection of a set of parameters; and
creating, based on the set of parameters, a structured data file, wherein:
a first field in an entry in the file includes a value from a first field in a first entry in the input file; and
a second field in the entry in the file includes a value from a second field in a second entry in the input file.

9. The method of claim 1, comprising:
associating at least one entry in at least one pattern with a rank value based on a relevance to an investigated event; and
presenting to a user the entry with the highest rank value.

10. The method of claim 9, comprising:
iteratively:
receiving input from the user indicating a level of relevance of the rank value to an investigated event;
based on the input, updating a rule for at least one of: identifying a pattern, and associating entries with rank values; and
presenting to a user the entry with the highest rank value.

11. A method of processing information related to an operation of a chip, the method comprising:
identifying at least one pattern of lines in an input file that records operation of a system; and
based on analyzing a plurality of occurrences of the pattern, selecting one or more lines that record a root cause of a problem related to the operation.

12. A system comprising:
a memory; and
a controller adapted to:
obtain an input file including entries that record an operation of a chip;
based on at least one parameter, identify at least one pattern of entries in the input file; and
based on analyzing a plurality of occurrences of the pattern, select an occurrence of the pattern that records a root cause of a problem.

13. The system of claim 12, wherein the controller is further adapted to:
receive from a user a selection of a field included in an entry including the parameter; and
visually present a set of entries including the parameter, wherein a visualization of an entry is according to a value included in the field.

14. The system of claim 12, wherein the controller is further adapted to:
receive from a user a selection of a function of an attribute of a field included in an entry including the parameter; and
based on the function, identify at least one pattern of entries in the input file.

15. The system of claim 12, wherein the controller is further adapted to:
visually present occurrences of each of the set of entries included in the pattern in a respective set of regions, wherein the occurrences are presented according to a common axis.

16. The system of claim 12, wherein the controller is further adapted to:
visually present occurrences of entries related to a set of parameters;
receive a selection of at least one of: one or more of the parameters and a range in a common axis used for presenting the occurrences; and
identify at least one pattern of entries in the input file based on the selection.

17. The system of claim 12, wherein the controller is further adapted to:
identify a plurality of patterns of entries in the input file; and
cluster the patterns based on an attribute of at least one field in at least one entry.

18. The system of claim 12, wherein the controller is further adapted to:
receive from a user a selection of a set of parameters; and
create, based on the set of parameters, a structured data file, wherein:
a first field in an entry in the file includes a value from a first field in a first entry in the input file; and
a second field in the entry in the file includes a value from a second field in a second entry in the input file.

19. The system of claim 12, wherein the controller is further adapted to:
associate at least one entry in at least one pattern with a rank value based on a relevance to an investigated event; and
present to a user the entry with the highest rank value.

20. The system of claim 19, wherein the controller is further adapted to:
iteratively:
receive input from the user indicating a level of relevance of the rank value to an investigated event;
based on the input, update a rule for at least one of: identifying a pattern, and associating entries with rank values; and
present to a user the entry with the highest rank value.
